(19) United States
(12) Patent Application Publication
(10) Pub. No.: US 2019/0313195 A1
(43) Pub. Date: Oct. 10, 2019

(54) MAGNET STRUCTURE FREE OF MAGNETIC FLUX LEAKAGE AND PANEL VIBRATION TYPE AUDIO GENERATING APPARATUS INCLUDING THE SAME

(71) Applicant: N CITRON, INC., Seongnam-si (KR)

(72) Inventors: Sungwoo KIM, Anyang-si (KR); Soomyung KIM, Seoul (KR); Yonguk LEE, Anyang-si (KR); Hyunwoo KIM, Seoul (KR)

(73) Assignee: N CITRON, INC., Seongnam-si (KR)

(21) Appl. No.: 16/230,282

(22) Filed: Dec. 21, 2018

(30) Foreign Application Priority Data
Apr. 6, 2018 (KR) 10-2018-0040261

(51) Int. Cl. H04R 9/06; H04R 9/02

(52) U.S. Cl. CPC H04R 9/06; H04R 2400/11; H04R 9/025

(57) ABSTRACT

The magnet structure and the audio generating apparatus including the same capable of minimizing magnetic flux leakage to reduce THD (Total Harmonic Distortion) are disclosed. The audio generating apparatus according to the present invention, which is attached to an inner surface of an audio device, includes: a frame provided with a through-hole; a suspension plate attached to the frame; a center magnet disposed under the suspension plate; a peripheral magnet surrounding the center magnet with a gap therebetween; a yoke accommodating the peripheral magnet; a voice coil having a lower end inserted in the gap between the center magnet and the peripheral magnet, wherein the voice coil is coupled to and inserted in the suspension plate to generate an electric field and vibrate vertically in response to an audio signal applied thereto; and a center pole having an upper end coupled to the suspension plate within the through-hole.

This non-provisional U.S. patent application claims priority under 35 U.S.C. § 119 of Korean Patent Application No. 10-2018-0040261, filed on Apr. 6, 2018, in the Korean Intellectual Property Office, the entire contents of which are hereby incorporated by reference.

### BACKGROUND OF THE INVENTION

### 1. Field

The present invention relates to a magnet structure and a panel vibration type audio generating apparatus including the same capable of preventing magnetic flux leakage.

### 2. Description of the Related Art

Speakers are mounted on various devices (hereinafter referred to as “audio devices”) such as television to reproduce audio signals audible to human ears. In particular, as televisions have recently become slimmer, speakers mounted in televisions are becoming slimmer accordingly.

In order to make speakers slimmer, a technique of slimming the components of a speaker such as cone paper has been developed as disclosed in Korean Patent Application Publications No. 10-2011-0067262 and No. 10-2013-0111906. However, as speakers are made slimmer, speaker with high output power is more difficult to obtain. Particularly, the performance of the speaker depends on the magnetic flux of the magnet. That is, when the leakage of magnetic flux occurs, the performance cannot be expected as designed from the speaker. Therefore, it is necessary to manufacture a slim speaker without any magnetic flux leakage capable of sufficient output power.

### SUMMARY OF THE INVENTION

It is an object of the present invention to provide a magnet structure and a panel vibration type audio generating apparatus including the same capable of preventing magnetic flux leakage.

According to one aspect of the present invention, there is provided a panel vibration type audio generating apparatus attached to an inner surface of an audio device, comprising: a frame provided with a through-hole; a suspension plate attached to the frame; a center magnet disposed under the suspension plate; a peripheral magnet surrounding the center magnet with a gap therebetween; a yoke accommodating the peripheral magnet; a voice coil having a lower end inserted in the gap between the center magnet and the peripheral magnet, wherein the voice coil is coupled to and inserted in the suspension plate to generate an electric field and vibrate vertically in response to an audio signal applied thereto; and a center pole having an upper end coupled to the suspension plate within the through-hole.

It is preferable that the center magnet comprises a disk-shaped magnet, and the peripheral magnet comprises a first arc-shaped magnet, a second arc-shaped magnet, a third arc-shaped magnet and a fourth arc-shaped magnet surrounding the disk-shaped magnet as a whole.

It is preferable that a magnetic pole of the center magnet and a magnetic pole of the peripheral magnet are opposite to each other in vertical direction.

It is preferable that the yoke comprises a groove at an inner surface thereof for accommodating the peripheral magnet.

It is preferable that the suspension plate comprises an edge member coupled to an upper surface of the frame along an outer circumference of the through-hole; a suspension member disposed inner than the edge member and suspended by a connecting member connected to the edge member; and a center member disposed inner than the suspension member and connected to the suspension member by a support member.

It is preferable that the suspension member further comprises guiding protrusions provided along an inner circumference thereof to guide a fixing position of the voice coil.

It is preferable that an upper end of the voice coil protrudes above the suspension plate and the lower end of the voice coil is inserted in the gap between the center magnet and the peripheral magnet within the through-hole.

It is preferable that the audio generating apparatus further comprises: an upper plate provided on an upper surface of the center magnet and coupled to a lower end of the center pole, wherein the lower end of the voice coil is inserted in the gap between the center magnet and the peripheral magnet via a gap between an outer circumferential surface of the upper plate and inner circumferential surface of the through-hole.

It is preferable that the audio generating apparatus further comprises: a guide ring provided at an upper end of the voice coil and attached to the inner surface of the audio device.

It is preferable that the audio generating apparatus further comprises: a ring plate provided along an upper surfaces of the yoke and the peripheral magnet.

It is preferable that the edge member comprises: a first edge member and a second edge member coupled to the upper surface of the frame along the outer circumference of the through-hole.

It is preferable that the connecting member comprises: a first connecting member and a second connecting member connected to the first edge member and the second edge member, respectively, and the suspension member comprises: a first suspension member disposed inner than the first edge member and suspended by the first connecting member; and a second suspension member disposed inner than the second edge member and suspended by the second connecting member.

It is preferable that the support member comprises: a first support member and a second support member connected to the first suspension member; and a third support member and a fourth support member connected to the second suspension member, and the center member comprises: a first center member disposed inner than the first suspension member and connected to the first suspension member via the first support member and the second support member; and a second center member disposed inner than the second suspension member and connected to the second suspension member via the third support member and the fourth support member.

It is preferable that the first edge member is electrically insulated from the second edge member, the first connecting member is electrically insulated from the second connecting member, the first suspension member is electrically insulated from the second suspension member, the first support member and the second support member are electrically insulated from the third support member and the fourth support member, and the first center member is electrically insulated from the second center member.

It is preferable that the first edge member, the first connecting member, the first suspension member, the first support member, the second support member and the first center member are electrically connected to one another, the second edge member, the second connecting member, the second suspension member, the second support member, the fourth support member and the second center member are electrically connected to one another.

It is preferable that the first edge member and the second edge member comprise a first terminal and a second terminal where the audio signal is applied, respectively, the audio signal applied to the first terminal and the second terminal being transmitted to the voice coil via: the first edge member, the first connecting member and the first suspension member; and the second edge member, the second connecting member and the second suspension member.

According to another aspect of the present invention, there is provided a magnet structure in an audio generating apparatus including a voice coil capable of generating an electric field in response to an audio signal, the magnet structure comprising: a center magnet; a peripheral magnet surrounding the center magnet with a gap therebetween; and a yoke accommodating the peripheral magnet, wherein a lower end of the voice coil is inserted in the gap between the center magnet and the peripheral magnet

It is preferable that the center magnet comprises a disk-shaped magnet, and the peripheral magnet comprises a first arc-shaped magnet, a second arc-shaped magnet, a third arc-shaped magnet and a fourth arc-shaped magnet surrounding the disk-shaped magnet as a whole.

It is preferable that a magnetic pole of the center magnet and a magnetic pole of the peripheral magnet are opposite to each other in vertical direction.

It is preferable that the yoke comprises a groove at an inner surface thereof for accommodating the peripheral magnet.

### BRIEF DESCRIPTION OF THE DRAWINGS

FIGS. 1A through 1D are a perspective view, a top view, a bottom view and an exploded perspective view of an audio generating apparatus according to the present invention, respectively.

FIG. 2 is a cross-sectional view of the audio generating apparatus taken along the line A-A of FIG. 1B according to the present invention.

FIGS. 3A and 3B are a perspective view and a partial enlarged view of the suspension plate 120 of the audio generating apparatus according to the present invention, respectively.

FIGS. 4A and 4B are a top view and a bottom view of a main part of the audio generating apparatus according to the present invention, respectively.

FIGS. 5A through 5C illustrate a magnet structure of the audio generating apparatus according to the present invention.

FIGS. 6A and 6B are cross-sectional views schematically illustrating a conventional magnet structure and the magnet structure according to the present invention, respectively.

FIGS. 7A and 7B illustrate magnetic lines of force of the conventional magnet structure and the magnet structure according to the present invention, respectively.

FIG. 8 is a graph illustrating magnetic flux distributions of the conventional magnet structure and the magnet structure according to the present invention.

### DETAILED DESCRIPTION OF THE PREFERRED EMBODIMENTS

Hereinafter, a slim speaker according to the present invention will be described in detail with reference to the accompanying drawings.

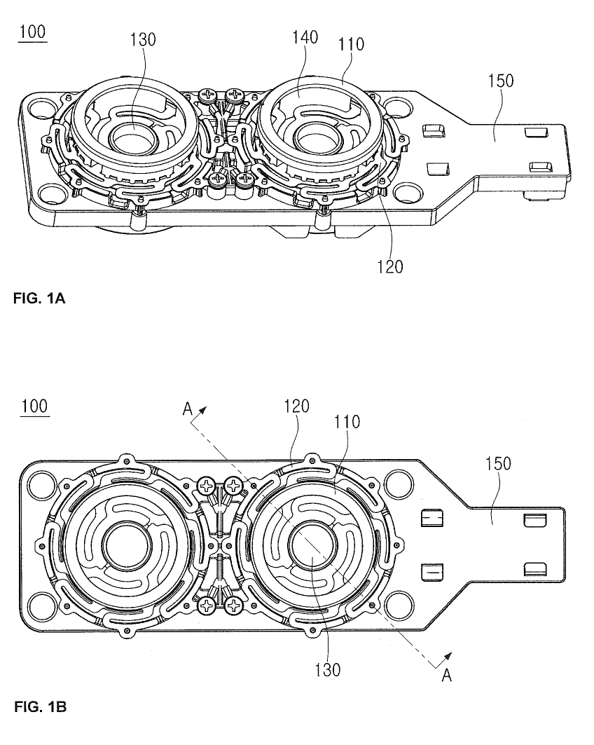

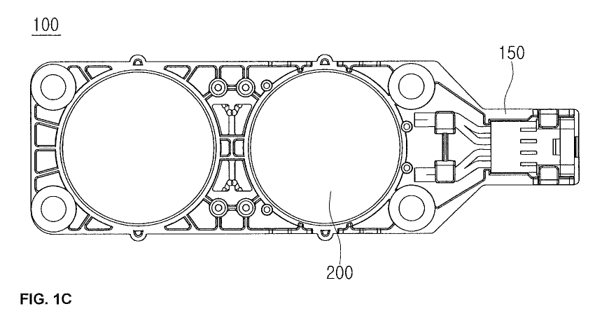

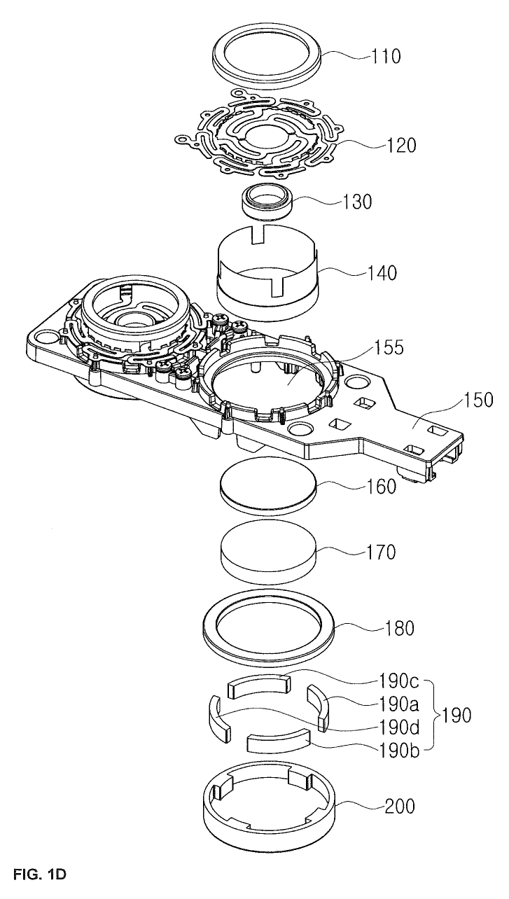

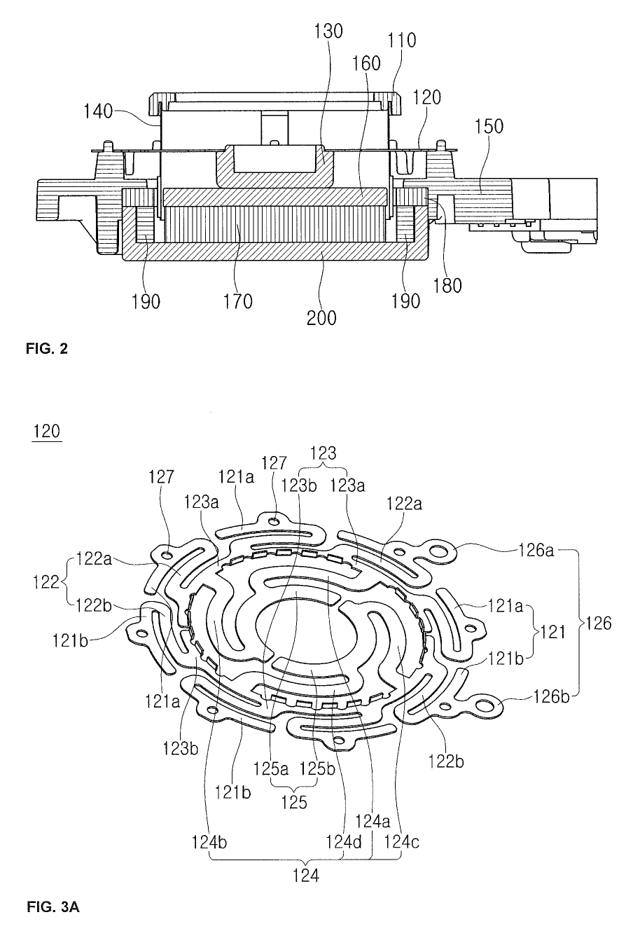

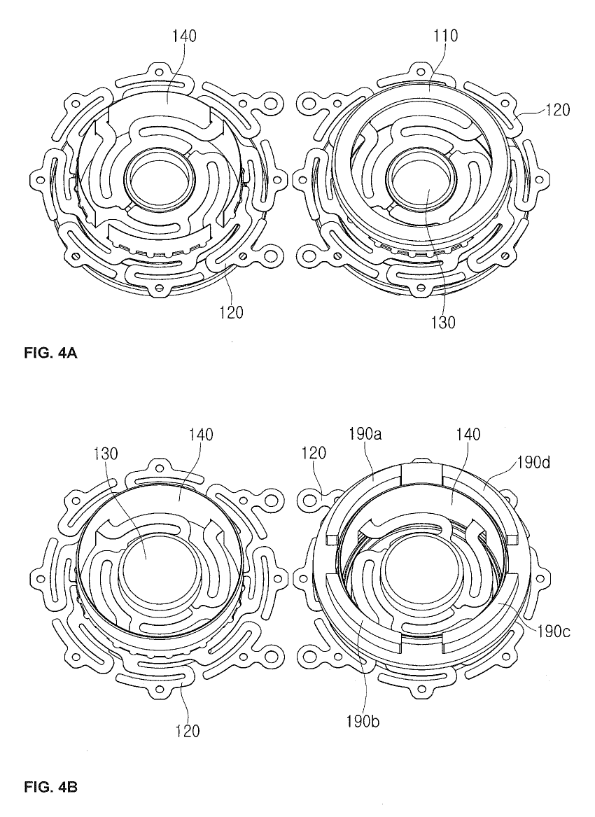

FIGS. 1A through 1D are a perspective view, a top view, a bottom view and an exploded perspective view of an audio generating apparatus 100 according to the present invention, respectively, and FIG. 2 is a cross-sectional view of the audio generating apparatus 100 taken along the line A-A of FIG. 1B according to the present invention. FIGS. 4A and 4B are a top view and a bottom view of a main part of the audio generating apparatus 100 according to the present invention, respectively.

Referring to FIGS. 1A through 1D, FIG. 2 and FIGS. 4A and 4B, the audio generating apparatus 100 according to the present invention includes a frame 150, a suspension plate 120, a center pole 130, a voice coil 140, a center magnet 170, a peripheral magnet 190 and a yoke 200. In addition, the audio generating apparatus 100 according to the present invention may further include a guide ring 110, an upper plate 160 and a ring plate 180.

The frame 150 is provided with a through-hole 155. The center pole 130, a lower end of the voice coil 140 and the upper plate 160 are disposed in the through-hole 155.

The voice coil 140 is cylindrical, and is inserted into and coupled to the suspension plate 120. The upper end of the voice coil 140 protrudes above the upper surface of the suspension plate 120, and the upper end of the voice coil 140 protrudes lower than the lower surface of the suspension plate 120 to be inserted into the through-hole 155. The voice coil 140 generates an electric field in response to the applied audio signal and vibrates vertically, i.e., along the center axis of the voice coil 140.

The suspension plate 120 includes a thin metal plate that damps the vibration of the voice coil 140. Specifically, the suspension plate 120 includes an edge member 121, a connecting member 122, a suspension member 123, a support member 124 and a center member 125.

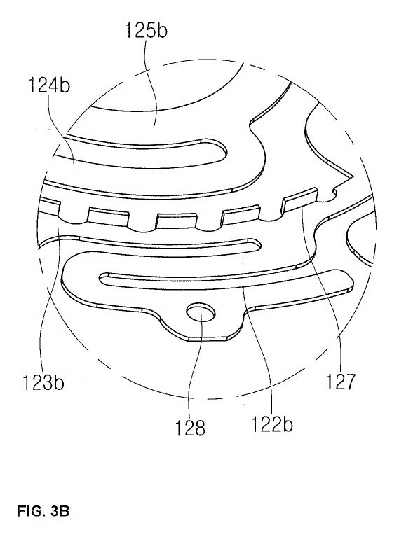

Hereinafter, the suspension plate 120 will be described in detail with reference to FIGS. 3A and 3B.

FIGS. 3A and 3B are a perspective view and a partial enlarged view of the suspension plate 120 of the audio generating apparatus 100, respectively.

Referring to FIGS. 3A and 3B, the edge member 121 extends in a circumferential direction of the suspension plate 120, and is coupled to the upper surface of the frame 150 along the circumference of the through-hole 155. The edge member 121 is preferably ring-shaped as a whole.

The connecting member 122 extends in the circumferential direction along the inner circumference of the edge member 121. The first end and the second end of the connecting member 122 disposed inner than the edge member 121 are connected to the edge member 121 and the suspension member 123, respectively. The suspension member 123 is provided inner than the connecting member 122 and extends in the circumferential direction along the inner circumference of the connecting member 122. The suspension member 123 is suspended by a connecting member 122. The suspension member 123 is preferably ring-shaped as a whole.

The support member 124 extends from the suspension member 123 in the circumferential direction along the inner circumference of the suspension member 123 and the first end and the second end are connected to the suspension member 123 and the center member 125, respectively. The center member 125 is provided inner than the suspension member 123 and the support member 124. The center member 125 is connected to the suspension member 123 via the support member 124. The center member 135 is preferably ring-shaped as a whole.

The center member 125 is coupled to the upper plate 160 by the center pole 130 and the edge member 121 is fixed to the upper surface of the frame 150 such that the suspension member 123 is suspended by the connecting member 122 and the support member 124. The voice coil 140 is coupled to and is in contact with the inner circumference of the suspension member 123 such that the voice coil 140 is also suspended along with the suspension member 123 and may freely vibrate vertically. In particular, as shown in FIG. 3B, the suspension member 123 may include guiding protrusions 127 along the inner circumference thereof. The guiding protrusions 127 guide and facilitate the fixing position of the voice coil 140. The guiding protrusions 127, together with the center pole 130, inhibit the voice coil 140 from vibrating (tilting) horizontally, that is, in the direction perpendicular to the center axis of the voice coil 140.

Hereinafter, the suspension plate 120 will be described in more detail.

As shown in FIG. 3A, the edge member 121 includes: a first edge member 121a; and a second edge member 121b each of which has an annulus sector shape. Each of the first edge member 121a and the second edge member 121b extends in the circumferential direction and coupled to the upper surface of the frame 150 along the circumference of the through-hole 155. The first edge member 121a and the second edge member 121b are electrically insulated from each other. Each of the first edge member 121a and the second edge member 121b is provided with a fixing hole 128, and a fixing protrusion (not shown) provided at the circumference of the through hole 155 is inserted into the fixing hole 128. The first edge member 121a and the second edge member 121b may be provided with a first terminal 126a and a second terminal 126b, respectively, to which an audio signal is applied.

The connecting member 122 includes: a first connecting member 122a; and a second connecting member 122b. The first connecting member 122a and the second connecting member 122b, which extend along the circumference direction, are provided inner than the inner circumference of the first edge member 121a and the second edge member 121b, respectively. The first ends of the first connecting member 122a and the second connecting member 122b are connected to the first edge member 121a and the second edge member 121b, and the second ends the first connecting member 122a and the second connecting member 122b are connected to a first suspension member 123a and a second suspension member 123b, respectively. The first connecting member 122a and the second connecting member 122b are electrically insulated from each other.

The suspension member 123 includes: a first suspension member 123a; and a second suspension member 123b. The first suspension member 123a is provided inner than the first edge member 121a and the first connecting member 122a, and extends in the circumferential direction and is suspended by the first connecting member 122a. The first suspension member 123a preferably has an annulus sector shape. The second suspension member 123b is provided inner than the second edge member 121b and the second connecting member 122b, and extends in the circumferential direction and is suspended by the second connecting member 122b. The second suspension member 123b preferably has an annulus sector shape. The first suspension member 123a and the second suspension member 123b are electrically insulated from each other.

The support member 124 includes: a first support member 124a; a second support member 124b; a third support member 124c; and a fourth support member 124d. The first support member 124a and the second support member 124b are provided inner than the first suspension member 123a and extend in the circumferential direction. The first ends of the first support member 124a and the second support member 124b are connected to the first suspension member 123a, and the second ends of the first support member 124a and the second support member 124b are connected to a first center member 125a. Each of the first support member 124a and the second support member 124b preferably has an annulus sector shape. The third support member 124c and the fourth support member 124d are provided inner than the second suspension member 123b and extend in the circumferential direction. The first ends of the third support member 124c and the fourth support member 124d are connected to the second suspension member 123b, and the second ends of the third support member 124c and the fourth support member 124d are connected to a second center member 125b. Each of the third support member 124c and the fourth support member 124d preferably has an annulus sector shape. The first support member 124a and the second support member 124b are electrically connected to each other and the third support member 124c and the fourth support member 124d are electrically connected to each other. The first support member 124a and the second support member 124b are electrically insulated from the third support member 124c and the fourth support member 124d.

The center member 125 includes: the first center member 125a; and the second center member 125b. The first center member 125a is provided inner than the first support member 124a and the second support member 124b, and extends in the circumferential direction. The second center member 125b is provided inner than the third support member 124c and the fourth support member 124d, and extends in the circumferential direction. The first center member 125a is connected to the first suspension member 123a by the first support member 124a and the second support member 124b, and the second center member 125b is connected to the second suspension member 123b by the third support member 124c and the fourth support member 124b. Each of the first center member 125a and the second center member 125b preferably has an annulus sector shapes. The first center member 125a and the second center member 125b are electrically insulated from each other and fixed by the center pole 130.

The first edge member 121a, the first connecting member 122a, the first suspension member 123a, the first support member 124a, the second support member 124b and the first center member 125a are electrically connected to one another, and the second edge member 121b, the second connecting member 122b, the second suspension member 123b, the third support member 124c, the fourth support member 124d and the second center member 125b are electrically connected to one another. Thus, the audio signal applied to the first terminal 126a is transmitted to the voice coil 140 via the first edge member 121a, the first connecting member 122a and the first suspension member 123a, and the audio signal applied to the second terminal 126b is transmitted to the second edge member 121b, the second suspension member 122b and the second suspension member 123b.

Referring back to FIGS. 1A through 1D and 2, the upper end of the center pole 130 provided in the through-hole 155 is coupled to the center member 125. The lower end of the center pole 130 is coupled to the center magnet 170 or the upper plate 160. Accordingly, the center member 125 is also fixed, whereby the suspension member 123 is suspended.

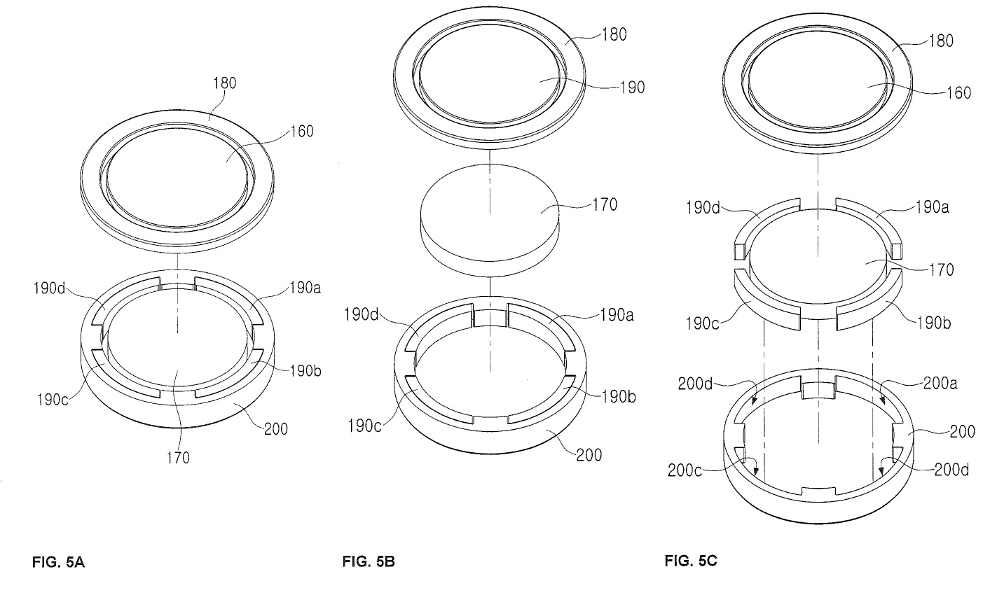

Hereinafter, a magnet structure of the audio generating apparatus according to the present invention will be described in detail with reference to FIGS. 5A through 5C.

FIGS. 5A through 5C illustrate a magnet structure of a panel vibration type audio generating apparatus according to the present invention.

Referring to 5A through 5C, the magnet structure of the panel vibration type audio generating apparatus according to the present invention includes: the center magnet 170; and a first peripheral magnet 190a, a second peripheral magnet 190b, a third peripheral magnet 190c and a fourth peripheral magnet 190d (collectively referred to as the peripheral magnet 190) surrounding and the center magnet 170. The first peripheral magnet 190a, the second peripheral magnet 190b, the third peripheral magnet 190c and the fourth peripheral magnet 190d are accommodated in a groove 200a, a groove 200b, a groove 200c and a groove 200d, respectively. The center magnet 170 is disposed in the space defined by the inner side surface of the peripheral magnet 190 and the inner side wall of yoke 200 in a manner that the outer side surface of the center magnet 170 is not in contact with the inner side surface of the peripheral magnet 190 and the inner side wall of the yoke 200. The lower end of the voice coil 140 is disposed in the space between the outer side surface of the center magnet 170, the inner side surface of the peripheral magnet 190 and the inner side wall of the yoke 200 as shown in FIG. 2. That is, at least the upper end of the center magnet 170 is provided inside the voice coil 140, and at least the upper end of the center magnet 170 is provided outside the voice coil 140. The upper plate 160 may be provided on the upper surface of the center magnet 170. The ring plate 180 may be provided on the upper surface of the peripheral magnet 190 and the upper surface of the yoke 200.

While four peripheral magnets 190 are shown in FIGS. 5A through 5C, the number of peripheral magnets 190 is not limited thereto. As long as the peripheral magnet 190 surround the center magnet 170, the number of the peripheral magnets 190 is irrelevant. For example, the number of the peripheral magnets 190 may be less than four or more than five. While disk-shaped center magnet 170 and arc-shaped first through fourth peripheral magnets 190a-190d are shown in FIGS. 5A through 5C, the shapes of the center magnet 170 and the first through fourth peripheral magnets 190a-190d are not limited thereto. For example, the center magnet 170 may be rectangular, and each of the first through fourth peripheral magnets 190a-190d may have L-shape to surround the center magnet 170.

The center magnet 170 and the peripheral magnet 190 form a magnetic field required for driving the audio generating apparatus. The voice coil 140 vibrates due to the magnetic field of the center magnet 170 and the peripheral magnet 190 and the electric field of the voice coil 140.

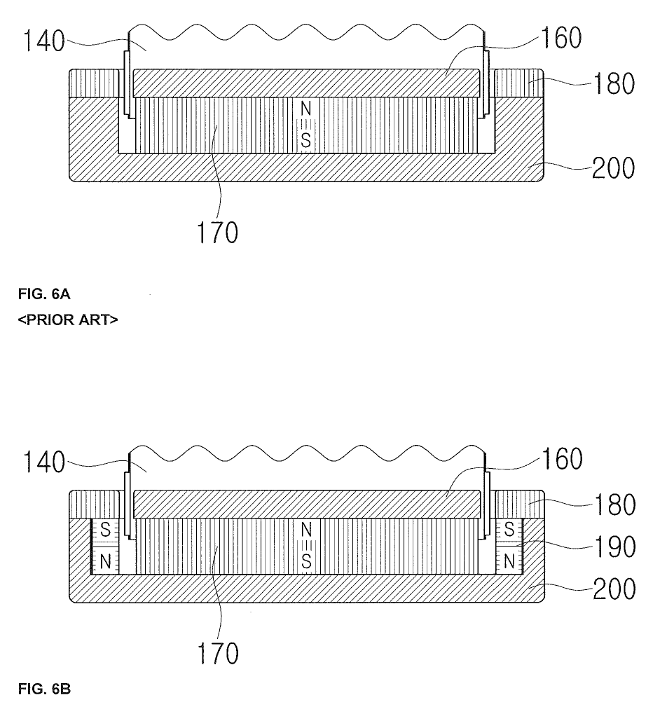

The magnet structure constituted by the center magnet 170 and the peripheral magnet 190 prevents the magnetic flux from leaking. This will be described in detail with reference to FIGS. 6A, 6B, 7 and 8.

FIGS. 6A and 6B are cross-sectional views schematically illustrating a conventional magnet structure and the magnet structure according to the present invention, respectively. Referring to FIG. 6A, the conventional magnet structure includes only center magnet 170. Referring to FIG. 6B, the magnet structure according to the present invention includes the center magnet 170 and the peripheral magnet 190. The magnetic pole of the peripheral magnet 190 is arranged opposite to that of the center magnet 170 according to the present invention as shown in FIG. 6B. That is, as shown in FIG. 6B, when the N pole of the center magnet 170 is at the top, the S pole of the peripheral magnet 190 at the top. Similarly, when the S pole of the center magnet 170 is at the top, the N pole of the peripheral magnet 190 is at the top.

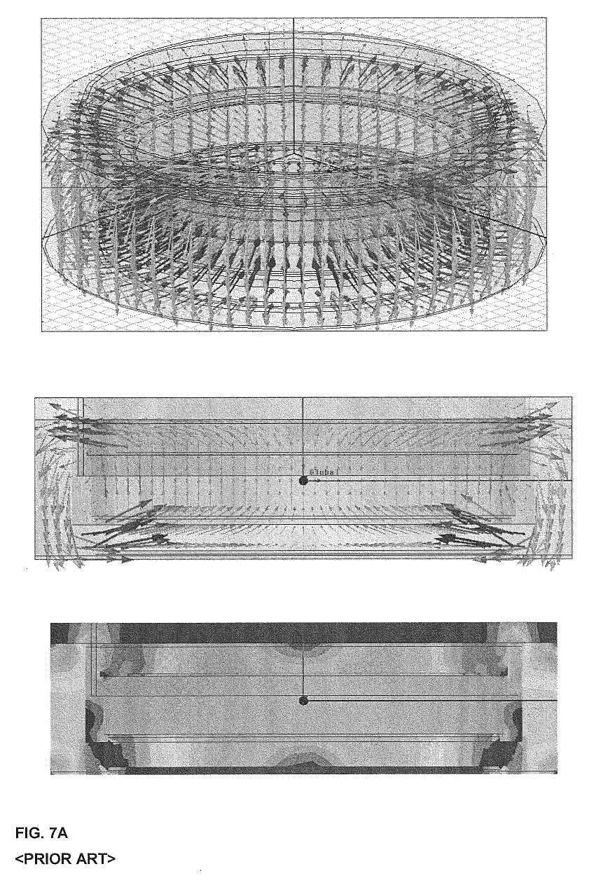

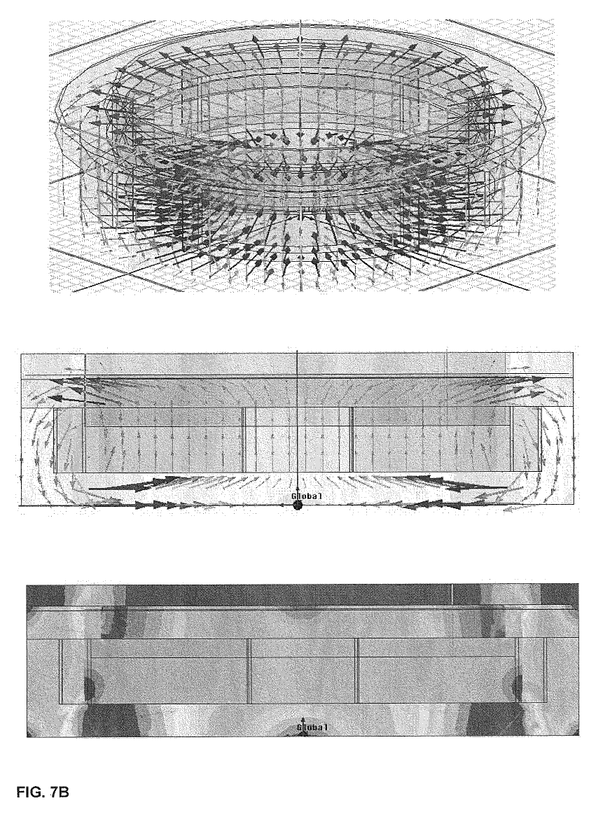

FIG. 7A illustrates magnetic lines of force of the conventional magnet structure, and FIG. 7B illustrates magnetic lines of force of the magnet structure according to the present invention. Referring to FIG. 7A, in the conventional magnet structure, the magnetic lines of force leaking along the sidewall of the yoke exist. Contrarily, in the magnet structure according to the present invention shown in FIG. 7B, there is almost no magnetic lines of force leaking along the sidewall of the yoke, and the magnetic field is concentrated (indicated by red).

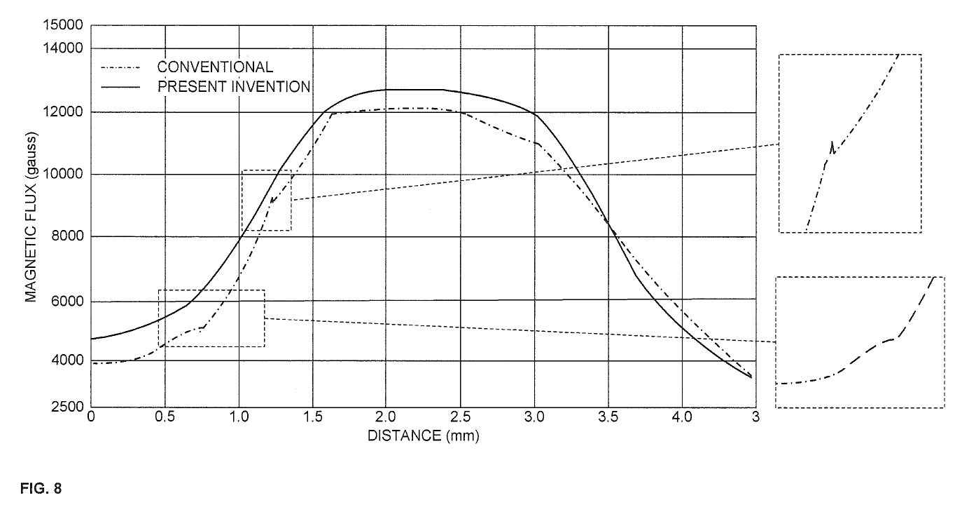

FIG. 8 is a graph illustrating magnetic flux distributions of the conventional magnet structure and the magnet structure according to the present invention. In FIG. 8, the vertical axis represents the intensity of the magnetic flux and the horizontal axis represents the distance from the lower end of the voice coil. Referring to FIG. 8, the magnet structure according to the present invention provides more symmetric and stable magnetic flux distribution compared to the conventional magnet structure. Particularly, while the magnetic flux distribution of the conventional magnet structure is not smooth and has sharp points, the magnetic flux distribution of the magnet structure according to the present invention is smooth and symmetric. Accordingly, the magnet structure according to the present invention has a lower THD (Total Harmonic Distortion) than the conventional magnet structure.

The audio generating apparatus 100 according to the present invention may further include the guide ring 110. The guide ring 110 is provided at the upper end of the voice coil 140 and is attached to the inner surface of an audio device. When an audio signal is applied to the audio generating apparatus 100 according to the present invention attached to the inner surface of the audio device, the movement of the voice coil 140 along the center axis thereof is generated and the movement is transmitted to the inner surface of the audio device to generate vibration. This vibration causes the audio contained in the audio signal to be reproduced. The guide ring 110 facilitates the attachment of the audio generating apparatus 100 according to the present invention to the inner surface of the audio device. The upper surface of the guide ring 110 may be provided with adhesive means (not shown) having an adhesive force such as a double-sided tape.

The audio generating apparatus 100 according to the present invention may further include the upper plate 160. The upper plate 160 is provided on the upper surface of the center magnet 170 and is coupled to the lower end of the center pole 130. A gap is provided between the outer circumferential surface of the upper plate 160 and the inner circumferential surface of the through-hole 155, and the lower end of the voice coil 140 is disposed in the gap. The voice coil 140 vibrates vertically (along the center axis of the voice coil) in the gap.

The magnet structure and the audio generating apparatus including the same according to the present invention minimize magnetic flux leakage to reduce THD (Total Harmonic Distortion).

What is claimed is:

1. A panel vibration type audio generating apparatus attached to an inner surface of an audio device, comprising:
a frame provided with a through-hole;
a suspension plate attached to the frame;
a center magnet disposed under the suspension plate;
a peripheral magnet surrounding the center magnet with a gap therebetween;
a yoke accommodating the peripheral magnet;
a voice coil having a lower end inserted in the gap between the center magnet and the peripheral magnet, wherein the voice coil is coupled to and inserted in the suspension plate to generate an electric field and vibrate vertically in response to an audio signal applied thereto; and
a center pole having an upper end coupled to the suspension plate within the through-hole.

2. The audio generating apparatus of claim 1, wherein the center magnet comprises a disk-shaped magnet, and the peripheral magnet comprises a first arc-shaped magnet, a second arc-shaped magnet, a third arc-shaped magnet and a fourth arc-shaped magnet surrounding the disk-shaped magnet as a whole.

3. The audio generating apparatus of claim 1, wherein a magnetic pole of the center magnet and a magnetic pole of the peripheral magnet are opposite to each other in vertical direction.

4. The audio generating apparatus of claim 1, wherein the yoke comprises a groove at an inner surface thereof for accommodating the peripheral magnet.

5. The audio generating apparatus of claim 1, wherein the suspension plate comprises an edge member coupled to an upper surface of the frame along an outer circumference of the through-hole; a suspension member disposed inner than the edge member and suspended by a connecting member connected to the edge member; and a center member disposed inner than the suspension member and connected to the suspension member by a support member.

6. The audio generating apparatus of claim 5, wherein the suspension member further comprises guiding protrusions provided along an inner circumference thereof to guide a fixing position of the voice coil.

7. The audio generating apparatus of claim 5, wherein an upper end of the voice coil protrudes above the suspension plate and the lower end of the voice coil is inserted in the gap between the center magnet and the peripheral magnet within the through-hole.

8. The audio generating apparatus of claim 7, further comprising: an upper plate provided on an upper surface of the center magnet and coupled to a lower end of the center pole, wherein the lower end of the voice coil is inserted in the gap between the center magnet and the peripheral magnet via a gap between an outer circumferential surface of the upper plate and inner circumferential surface of the through-hole.

9. The audio generating apparatus of claim 1, further comprising: a guide ring provided at an upper end of the voice coil and attached to the inner surface of the audio device.

10. The audio generating apparatus of claim 1, further comprising: a ring plate provided along an upper surfaces of the yoke and the peripheral magnet.

11. The audio generating apparatus of claim 5, wherein the edge member comprises: a first edge member and a second edge member coupled to the upper surface of the frame along the outer circumference of the through-hole.

12. The audio generating apparatus of claim 11, wherein the connecting member comprises: a first connecting member and a second connecting member connected to the first edge member and the second edge member, respectively, and the suspension member comprises: a first suspension member disposed inner than the first edge member and suspended by the first connecting member; and a second suspension member disposed inner than the second edge member and suspended by the second connecting member.

13. The audio generating apparatus of claim 12, wherein the support member comprises: a first support member and a second support member connected to the first suspension member; and a third support member and a fourth support member connected to the second suspension member, and the center member comprises: a first center member disposed inner than the first suspension member and connected to the first suspension member via the first support member and the second support member; and a second center member disposed inner than the second suspension member and connected to the second suspension member via the third support member and the fourth support member.

14. The audio generating apparatus of claim 13, wherein the first edge member is electrically insulated from the second edge member, the first connecting member is electrically insulated from the second connecting member, the first suspension member is electrically insulated from the second suspension member, the first support member and the second support member are electrically insulated from the third support member and the fourth support member, and the first center member is electrically insulated from the second center member.

15. The audio generating apparatus of claim 14, wherein the first edge member, the first connecting member, the first suspension member, the first support member, the second support member and the first center member are electrically connected to one another, the second edge member, the second connecting member, the second suspension member, the second support member, the fourth support member and the second center member are electrically connected to one another.

16. The audio generating apparatus of claim 15, wherein the first edge member and the second edge member comprise a first terminal and a second terminal where the audio signal is applied, respectively, the audio signal applied to the first terminal and the second terminal being transmitted to the voice coil via: the first edge member, the first connecting member and the first suspension member; and the second edge member, the second connecting member and the second suspension member.

17. A magnet structure in an audio generating apparatus including a voice coil capable of generating an electric field in response to an audio signal, the magnet structure comprising:
a center magnet;
a peripheral magnet surrounding the center magnet with a gap therebetween; and
a yoke accommodating the peripheral magnet,
wherein a lower end of the voice coil is inserted in the gap between the center magnet and the peripheral magnet.

18. The magnet structure of claim 17, wherein the center magnet comprises a disk-shaped magnet, and the peripheral magnet comprises a first arc-shaped magnet, a second arc-shaped magnet, a third arc-shaped magnet and a fourth arc-shaped magnet surrounding the disk-shaped magnet as a whole.

19. The magnet structure of claim 17, wherein a magnetic pole of the center magnet and a magnetic pole of the peripheral magnet are opposite to each other in vertical direction.

20. The magnet structure of claim 17, wherein the yoke comprises a groove at an inner surface thereof for accommodating the peripheral magnet.
